(19) United States
(12) Patent Application Publication
(10) Pub. No.: US 2025/0139047 A1
(43) Pub. Date: May 1, 2025

(54) Dynamic Initiator Throttling in Network-on-Chip

(71) Applicant: Altera Corporation, San Jose, CA (US)

(72) Inventor: Przemek Guzy, Oakville (CA)

(21) Appl. No.: 19/004,255

(22) Filed: Dec. 28, 2024

(51) Int. Cl. G06F 13/42

(52) U.S. Cl. CPC G06F 13/42

(57) ABSTRACT

Systems, methods, and circuitry for dynamic control of a network-on-chip (NOC) of an integrated circuit device are provided. An integrated circuit device may include first circuitry, second circuitry, and a network-on-chip (NOC). The NOC may transfer packetized data from an initiator bridge connected to the first circuitry to a target bridge connected to the second circuitry and dynamically limit a transmission rate of the initiator bridge based on a network condition of the NOC.

### BACKGROUND

This disclosure relates to systems and methods for managing network-on-chip congestion on an integrated circuit device, such as a field programmable gate array (FPGA).

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it may be understood that these statements are to be read in this light, and not as admissions of prior art.

Integrated circuits are found in numerous electronic devices and provide a variety of functionality. Many integrated circuits include programmable logic circuitry that may be configured with a hardware system design to implement hardware designs that may perform a wide variety of different functions. In addition to programmable logic circuitry, many integrated circuits also include hardened circuits to perform special-purpose operations, such as digital signal processing (DSP) blocks with hardened arithmetic circuitry or a network-on-chip (NOC) to perform hardened data transfer around the integrated circuit. A NOC includes a number of routers connected to nodes referred to as initiator bridges and target bridges where packetized data can enter and exit, allowing the data to be readily transferred from one area of the integrated circuit to another. If too much data fills the NOC at any time, however, traffic in flight along the NOC fabric may become queued up in buffers in the routers along the way. Back pressure long enough, and the buffers fill, and no more traffic is able to get through the NOC. This slows down all traffic moving through common areas of the NOC.

Many NoC implementations include initiator bridges with static throttling settings. These settings can restrict the bandwidth entering the NOC by backpressuring the programmable logic circuitry that has been configured with the user logic that drives the initiator bridge. The throttling setting may indicate the amount of back pressure applied as a function of bandwidth and may be set in a programmable logic device, such as field programmable gate array (FPGA), at a design compile time. To do so, a user developing the system design that will be programmed in the programmable logic device may predict an optimal amount of throttling. This is problematic because the appropriate amount of throttling can be dependent upon the specific traffic patterns on the NOC at any given time. To prevent a situation where the NOC becomes clogged, a worst-case throttling setting is often chosen. Yet the worst-case setting may artificially restrict the bandwidth of an initiator at times when NOC traffic is not worst-case. Furthermore, even determining the worst-case setting is difficult. Doing so may involve running the real design with real traffic/usage patterns, then determining that available bandwidth has dropped, and then, through trial and error, applying throttling settings to the various bridges in the design. This trial-and-error approach is both time consuming (involving many recompiles) and error prone since it is not obvious which initiator bridge should be throttled to resolve a clog.

### BRIEF DESCRIPTION OF THE DRAWINGS

Various aspects of this disclosure may be better understood upon reading the following detailed description and upon reference to the drawings in which:

FIG. 1 is a block diagram of a system used to program a system design onto an integrated circuit device;

FIG. 2 is a block diagram of an example integrated circuit device that may be programmed with a system design;

FIG. 3 is a block diagram of a network-on-chip (NOC) of the integrated circuit device that may dynamically throttle an initiator bridge of the NOC based on dynamic network conditions;

FIG. 4 is a flowchart of a method for dynamically throttling an initiator bridge of the NOC based on dynamic network conditions;

FIG. 5 is a block diagram of a network-on-chip (NOC) of the integrated circuit device that may use a central traffic manager to dynamically throttle an initiator bridge of the NOC based on dynamic network conditions;

FIG. 6 is a flowchart of a method for dynamically throttling an initiator bridge of the NOC based on dynamic network conditions using a central traffic manager; and

FIG. 7 is a block diagram of a data processing system that may incorporate the NOC of this disclosure.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Many integrated circuit devices include a network-on-chip (NOC) to efficiently send packetized data from one part of the integrated circuit device to another. A NOC includes a number of routers connected to nodes referred to as initiator bridges and target bridges where packetized data can enter and exit, allowing the data to be readily transferred from one area of the integrated circuit to another. Rather than use initiator bridges with static throttling settings, which prevent worst-case data congestion by ensuring that utilization of the NOC remains below its potential, the NOC may dynamically throttle initiator bridges based on dynamic network conditions. For example, target bridges or routers of the NOC may detect when packets from a particular initiator bridge are not egressing fast enough. A throttling response may be issued that causes the initiator bridge to dynamically throttle to allow network congestion to clear. A throttling response may be issued to an initiator bridge by a target bridge or router of the NOC or by a central traffic manager.

The NOC may be used in any suitable integrated circuit device, but may be especially useful when used in a programmable logic device, such as field programmable gate array (FPGA). This is because the system design that is programmed into a programmable logic device is often done by a system designer (e.g., user) rather than a manufacturer of the programmable logic device. What is more, this may allow the system designer to allocate significantly more NOC bandwidth without costly and time-consuming modeling, since network congestion may be compensated for dynamically.

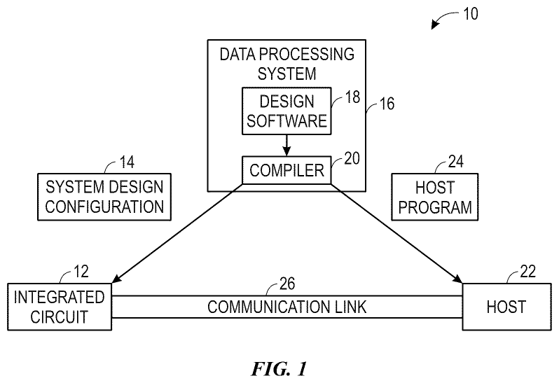

FIG. 1 illustrates a block diagram of a system 10 that may be used to program an integrated circuit device 12, such as an FPGA (e.g., Agilex™, Stratix®, Arria®, MAX®, or Cyclone® devices by Altera® Corporation), with a system design using a system design configuration 14. Note that, while this disclosure largely refers to the integrated circuit device 12 as being a programmable logic device, such as an FPGA, in some embodiments, the integrated circuit device 12 may also be a one-time programmable device or structured application specific integrated circuit (ASIC), such as an Intel® eASIC™ device by Intel® Corporation. In other examples, the integrated circuit device 12 may be any suitable integrated circuit that is manufactured to have a particular system design with circuitry to perform desired data processing operations. The integrated circuit device 12 may be a single monolithic integrated circuit or a multi-die system of integrated circuits. The integrated circuit device 12 may include a single integrated circuit, multiple integrated circuits in a package, or multiple integrated circuits in multiple packages communicating remotely (e.g., via wires or traces) and may be referred to as an integrated circuit device or an integrated circuit system whether formed from a single integrated circuit or multiple integrated circuits in a package.

A designer may desire to implement the system design 14 (sometimes referred to as a circuit design or configuration) to perform a wide variety of possible operations on the integrated circuit device 12. In some cases, the designer may specify a high-level program to be implemented, such as an OPENCL® program that may enable the designer to more efficiently and easily provide programming instructions to configure a set of programmable logic cells for the integrated circuit device 12 without specific knowledge of low-level hardware description languages (e.g., Verilog, very high-speed integrated circuit hardware description language (VHDL)). For example, since OPENCL® is quite similar to other high-level programming languages, such as C++, designers of programmable logic familiar with such programming languages may have a reduced learning curve than designers that are required to learn unfamiliar low-level hardware description languages to implement new functionalities in the integrated circuit device 12.

In a configuration mode of the integrated circuit device 12, a designer may use a data processing system 16 (e.g., a computer including a data processing system having a processor and memory or storage) to implement high-level designs (e.g., a system user design) using design software 18 (e.g., executable instructions stored in a tangible, non-transitory, computer-readable medium such as the memory or storage of the data processing system 16), such as a version of INTEL® QUARTUS® by INTEL CORPORATION. The data processing system 16 may use the design software 18 and a compiler 20 to convert the high-level program into a lower-level description (e.g., a configuration program, a bitstream) as the system design configuration 14. The compiler 20 may provide machine-readable instructions representative of the high-level program to a host 22 and the system design configuration 14 to the integrated circuit device 12.

Additionally or alternatively, the host 22 running the host program 24 may control or implement the system design configuration 14 onto the integrated circuit device 12. For example, the host 22 may communicate instructions from the host program 24 to the integrated circuit device 12 via a communications link 26 that may include, for example, direct memory access (DMA) communications or peripheral component interconnect express (PCIe) communications. The designer may use the design software 18 to generate and/or to specify a low-level program, using low-level tools such as the low-level hardware description languages described above. Further, in some embodiments, the system 10 may be implemented without a separate host 22 or host program 24. Thus, embodiments described herein are intended to be illustrative and not limiting.

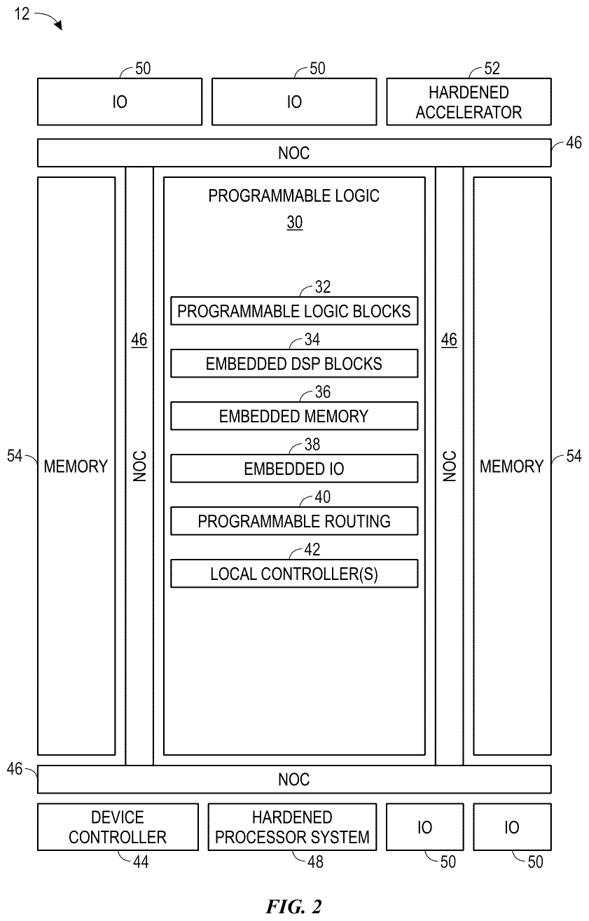

The integrated circuit device 12 may take any suitable form that may implement the system design configuration 14. In one example shown in FIG. 2, the integrated circuit device 12 may include programmable logic 30, which include a two-dimensional array of many different functional blocks, such as programmable logic blocks 32, embedded digital signal processing (DSP) blocks 34, embedded memory blocks 36, and embedded input-output blocks 38. In many cases, there may be rows or columns of these functional blocks that may be programmably connected to one another using programmable routing 40.

The programmable logic blocks 32 may be programmed to implement a wide variety of logic circuitry. The programmable logic blocks 32 may include a number of adaptive logic modules (ALMs), which may take the form of lookup tables (LUTs) that can be programmed to implement a logic truth table, effectively enabling any the programmable logic blocks 32 to implement any desired logic circuitry when configured with the system design configuration 14. The programmable logic blocks 32 and are sometimes referred to as logic array blocks (LABs) or configurable logic blocks (CLBs).

The embedded DSP blocks 34, embedded memory blocks 36, and embedded IO blocks 38 may be distributed around the programmable logic blocks 32. For example, there may be several columns of programmable logic blocks 32 for every column of DSP blocks 34, column of embedded memory blocks 36, or column of embedded IO blocks 38. The embedded DSP blocks 34 may include “hardened” circuits that are specialized to efficiently perform certain arithmetic operations. This is in contrast to “soft logic” circuits that may perform the same functions by programming the programmable logic blocks 32, but which may not be as efficient as the hardened circuits of the DSP blocks 34. The embedded memory blocks 36 may include dedicated local memory (e.g., blocks of 20 kB, blocks of 1 MB). The embedded IO blocks 38 may allow for certain inter-die or inter-package communication. The embedded DSP blocks 34, embedded memory blocks 36, and embedded IO blocks 38 may be accessible to the programmable logic blocks 32 using the programmable routing 40.

The various functional blocks of the programmable logic 30 may be grouped into programmable regions, sometimes referred to as logic sectors, that may be individually managed and configured by corresponding local controllers 42 (e.g., sometimes referred to as Local Sector Managers (LSMs)). The grouping of the programmable logic 30 resources on the integrated circuit device 12 into logic sectors, logic array blocks, logic elements, or adaptive logic modules is merely illustrative. In general, the integrated circuit device 12 may include functional logic blocks of any suitable size and type, which may be organized in accordance with any suitable logic resource hierarchy. Indeed, there may be other functional blocks (e.g., other embedded application specific integrated circuit (ASIC) blocks) than those shown in FIG. 2.

Before continuing, it may be noted that the programmable logic 30 circuitry of the integrated circuit device 12 may be controlled by programmable memory elements sometimes referred to as configuration random access memory (CRAM). Memory elements may be loaded with configuration data (also called programming data or a configuration bitstream) that represents the system design configuration 14. Once loaded, the memory elements may provide a corresponding static control signal that controls the operation of an associated functional block. In one scenario, the outputs of the loaded memory elements are applied to the gates of metal-oxide-semiconductor transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, and the like. The configuration memory elements may use any suitable volatile and/or non-volatile memory structures such as random-access-memory (RAM) cells, fuses, antifuses, programmable read-only-memory (ROM) memory cells, mask-programmed, laser-programmed structures, or combinations of structures such as these.

A device controller 44, sometimes referred to as a secure device manager (SDM), may manage the operation of the integrated circuit device 12. The device controller 44 may include any suitable logic circuitry to control and/or program the programmable logic 30 or other elements of the integrated circuit device 12. For example, the device controller 44 may include a processor (e.g., an x86 processor or a reduced instruction set computer (RISC) processor, such as an Advanced RISC Machine (ARM) processor or a RISC-V processor) that executes instructions stored on any suitable tangible, non-transitory, machine-readable media (e.g., memory or storage). Additionally or alternatively, the device controller 44 may include a hardware finite state machine (FSM). The device controller 44 may provide other functions, such as serving as a platform for virtual machines that may manage the operation of the integrated circuit device 12.

A network-on-chip (NOC) 46 may connect the various elements of the integrated circuit device 12. The NOC 46 may provide rapid, packetized communication to and from the programmable logic 30 and other blocks, such as a hardened processor system 48, high-speed input-output (IO) blocks 50, a hardened accelerator 52, and local device memory 54. The integrated circuit device 12 may include the hardened processor system 48 when the integrated circuit device 12 takes the form of a system-on-chip (SOC). The hardened processor system 48 may include a hardened processor (e.g., an x86 processor or a reduced instruction set computer (RISC) processor, such as an Advanced RISC Machine (ARM) processor or a RISC-V processor) that may act as a host machine on the integrated circuit device 12. The high-speed IO blocks 50 may enable communication using any suitable communication protocol(s) with other devices outside of the integrated circuit device 12, such as a separate memory device. The hardened accelerator 52 may include any hardened application-specific integrated circuitry (ASIC) logic to perform a desired acceleration function. For example, the hardened accelerator 52 may include hardened circuitry to perform cryptographic or media encoding or decoding. The memory 54 may provide local device memory (e.g., cache) that may be readily accessible by the programmable logic 30.

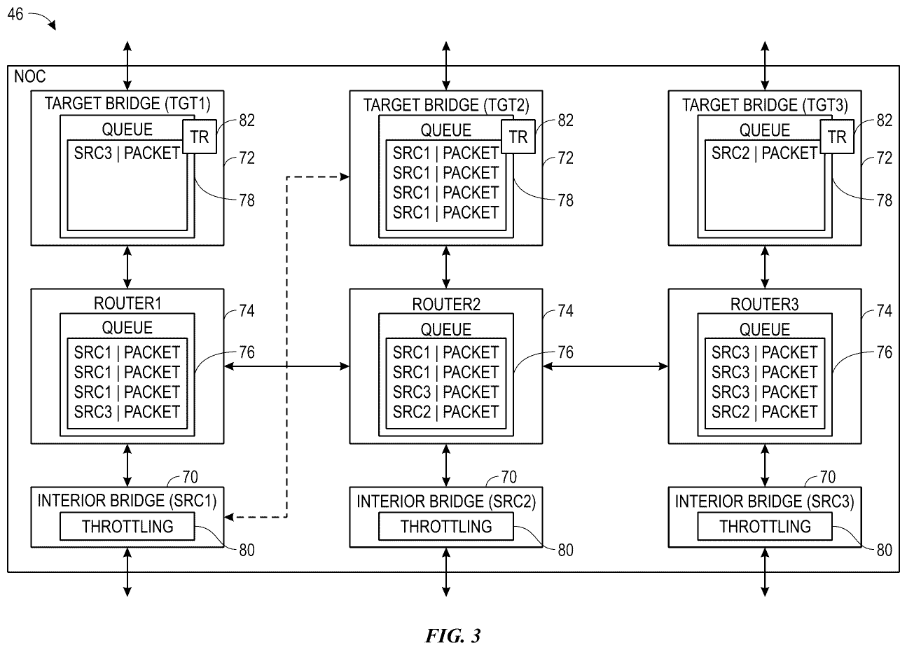

FIG. 3 provides an example block diagram of the NOC 46. The NOC 46 may route data loaded on initiator bridges 70 to specific target bridges 72 by over routers 74. Data packets are loaded onto a particular initiator bridge 70 and are transferred from router 74 to router 74 until reaching a particular target bridge 72. The routers 74 may include first-in-first-out (FIFO) queues 76 that store data packets before they are routed according to any suitable network specifications to a next router 74 or out to a target bridge 72. The target bridges 76 may include FIFO queues 78, where the data packets are held until they can be offloaded. The initiator bridges 70 and the target bridges 72 may be located at any circuitry of the integrated circuit device 12 along the NOC 46. Indeed, although the programmable logic 30 may generally be expected to connect mostly to initiator bridges 70 and other elements such as the IOs 50 may generally be expected to connect mostly to target bridges 72, the opposite arrangement may also take place.

In the example of FIG. 3, there are three initiator bridges 70 labeled “SRC1,” “SRC2,” and “SRC3,” three routers 74 labeled “Router1,” “Router2,” and “Router3,” and there are three target bridges 72 labeled “TGT1,” “TGT2,” and “TGT3.” Packets from the initiator bridges 70 may include an indication of both (1) which target bridge 72 that the packets are intended for as well as (2) the initiator bridges 70 that sent them. To prevent the NOC 46 from becoming clogged with data packets that overwhelm the ability of the NOC 46 to operate properly, the initiator bridges 70 may include throttling circuitry 80. The throttling circuitry 80 of each initiator bridge 70 may limit the rate at which data packets are placed onto the NOC 46 by that initiator bridge 70. For example, the throttling circuitry 80 of a particular initiator bridge 70 may define that that initiator bridge 70 is to operate at some percentage of a maximum possible packet transmission rate (e.g., 99%, 95%, 90%, 80%, 70% 60%, 50%, 25%, 10%, 5%). The throttling circuitry 80 may take the form of any suitable logic circuitry (e.g., a finite state machine (FSM), a microcontroller that executes instructions stored in memory).

Rather than define the throttling rate based on a static transmission or static throttling rate specified in the system design configuration 14 that always remains the same during runtime, the throttling circuitry 80 may dynamically adjust the rate based on network conditions. For example, throttling response (TR) circuitry 82 in each target bridge 72 may analyze the fullness of the queue 78 and issue a throttling response to an initiator bridge 70. The throttling response (TR) circuitry 82 may take the form of any suitable logic circuitry (e.g., a finite state machine (FSM), a microcontroller that executes instructions stored in memory). Note that, in other embodiments, the routers 74 may also include respective throttling response (TR). In the example illustrated in FIG. 3, the second target bridge 72 (TGT2) may determine that its queue 78 has reached a threshold level of fullness with data packets from the first initiator bridge 70 (SRC1). The second target bridge 72 (TGT2) may send a throttling response back to the first initiator bridge 70 (SRC1) over the NOC 46 (e.g., through the second router 74 (Router2) and the first router 74 (Router1)).

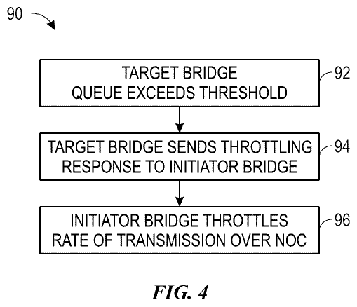

A flowchart 90 of FIG. 4 broadly describes such a method for dynamic throttling. The flowchart 90 begins as a target bridge 72 determines that its queue 78 has reached a threshold level of fullness (process block 92). The threshold may be set in a number of different ways. These threshold methods may be programmable and may be operable separately or together. In one example, the threshold may be a static setting (e.g., as a percentage of the FIFO capacity of the queue 78). The static setting may be defined by a user in the system design configuration 14 and would likely be less than 100%.

In another example, the threshold may be a predictive setting based on a previous throttling response threshold and its effectiveness. Thus, the threshold may be an initially higher level of fullness. If, after some period of time (e.g., as counted by a counter) after the target bridge 72 sends a throttling response, the level of fullness has not decreased, another throttling response may be sent and the threshold may be lowered to a subsequently lower level of fullness. For example, the target bridge 72 may determine if the last time the throttling threshold was exceeded, did the queue 78 still get filled even after the throttling response went out? If so, the threshold may be lowered. In effect, this is measuring the latency of the NOC 46.

In another example, the threshold may be selected—whether alone or in combination with the techniques discussed above—using other metrics. These other metrics may include quality of service (QOS) settings of the pending data packets and even the total number of pending packets from specific sources. On this basis, the throttling response commands may be sent to only a subset of the initiator bridges 70 (e.g., those with lower QoS settings and/or higher number of pending packets).

Having determined that its queue 78 exceeds the threshold, the target bridge 72 may send a throttling response to an initiator bridge 70 (process block 94). There may be a single form of throttling response command or multiple different types that indicate a varying degree of criticality. For example, the target bridge 72 may send a first type of throttling response upon determining that its queue 78 exceeds a first threshold and may send a second type of throttling response upon determining that its queue 78 exceeds a second, higher threshold. The initiator bridge 70 may take action based on the type of throttling response command that it receives.

Upon receipt of the throttling response, the initiator bridge 70 may throttle the rate of data transmission over the NOC 46 (process block 96). Throttling response commands can be handled in a number of ways by the initiator bridges 70. These different methods may be programmable and may be operable separately or together.

In one example, the throttling response commands may trigger in the initiator bridge 70 a binary on-off effect. Essentially, the throttling response commands may operate as a backpressure enable signal. This mode may involve a timer or a follow-up response from the target bridge to unblock. For example, an initiator bridge 70 that receives a throttling response command may halt all data packet transmission and apply backpressure to the logic circuitry that is supplying the data. The transmission may be halted until an enable packet is received from the target bridge 72 indicating that its queue 78 has cleared enough to receive new data, until a timer has indicated that a threshold amount of time has passed since the transmission was halted, or until either of these things occurs.

In another example, the throttling response commands may trigger in the initiator bridge 70 a fixed drop in bandwidth. For example, there may be a full bandwidth and a reduced bandwidth state (which may be programmable in the system design configuration 14). The initiator bridge 70 may enter a defined reduced bandwidth state upon receipt of a throttling response command. This may be a comparatively low, minimum bandwidth. A timer may be set upon receipt of the throttling response command. The timer may count down to a resumption time (e.g., which may be programmable in the system design configuration 14), upon which the initiator bridge 70 may resume full bandwidth traffic.

In another example, the throttling response commands may trigger in the initiator bridge 70 an incremental reduction in bandwidth. For instance, every time a throttling response command is received, the initiator bridge 70 may reduce bandwidth by some programmable percentage. A timer may be set to count down to a defined (e.g., programmable) time at which to slowly (or quickly) increase the bandwidth. For example, upon receipt of a first throttling response command, the initiator bridge 70 may reduce bandwidth to 90%. If a second throttling response command is received before expiration of the timer, the initiator bridge 70 may reduce bandwidth to 80%, and so on.

Using a combination of the predictive throttling threshold and incremental bandwidth reduction mentioned above, it may be possible for the NOC 46 to dynamically adjust to a wide variety of different bandwidth situations. Note that, in all of the above examples, the routers 74 may also monitor their own queues 76 and issue throttling commands just like the target bridges 72. This enhancement may also have the effect of more accurately targeting the source of the bandwidth overload rather than throttling all sources.

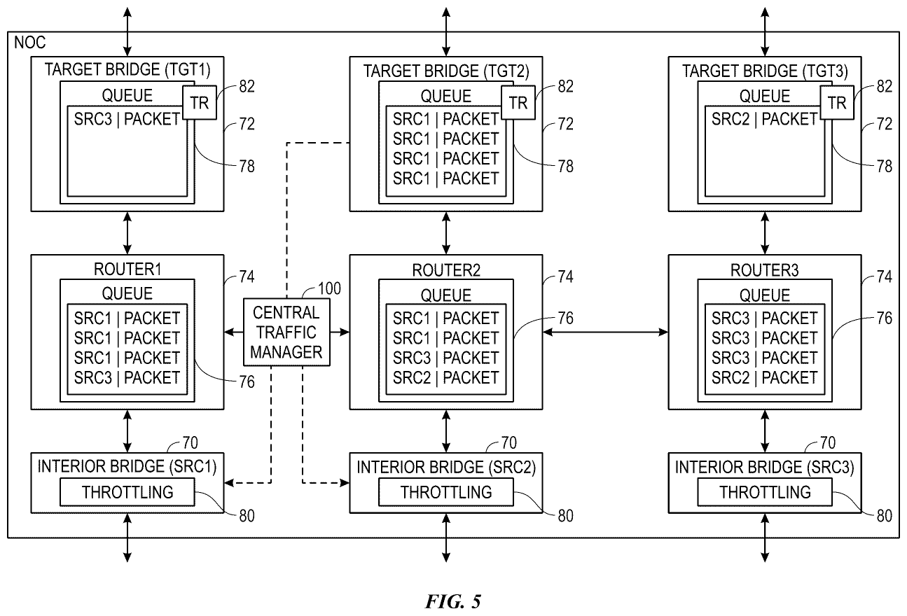

FIG. 5 provides an example block diagram of the NOC 46 including a central traffic manager 100. The central traffic manager 100 may take the form of any suitable logic circuitry (e.g., a finite state machine (FSM), a microcontroller that executes instructions stored in memory). In the example of FIG. 5, the target bridges 72 and/or the routers 74 may send throttling response packets back to the central traffic manager 100 rather than, or in addition to, sending throttling response packets to the initiator bridges 70. The central traffic manager 100 may have a more global awareness of dynamic congestion on the NOC 46. For example, the central traffic manager 100 may take into account relative QoS specifications of different regions of circuitry of the system design configuration 14. The central traffic manager 100 may then issue a throttling command back to specific initiator bridges 70 to shape traffic, appropriately taking into account relative QoS requirements. For example, in the example of FIG. 5, the second target bridge 72 (TGT2) may determine that its queue 78 has reached a threshold level of fullness with data packets from the first initiator bridge 70 (SRC1). The second target bridge 72 (TGT2) may send a throttling response to the central traffic manager 100. The central traffic manager 100 may, based on a global QoS setting, determine to throttle the first initiator bridge 70 (SRC1) and the second initiator bridge 70 (SRC2) by issuing a throttling response command to those initiator bridges 70.

FIG. 6 provides a flowchart 120 that illustrates an approach involving a central traffic manager 100. The flowchart 120 begins as a target bridge 72 determines that its queue 78 has reached a threshold level of fullness (process block 122). The target bridge 72 may send a throttling response to the central traffic manager 100 (process block 124). The central traffic manager 100 may determine, based on QoS settings (e.g., indicating which initiator bridges 70 may be generally prioritized or which circuitry in the system design configuration 14 are generally prioritized), to send the throttling response command to certain initiator bridges 70 (process block 126). The initiator bridges 70 that the central traffic manager 100 sends the throttling response messages to may include more or fewer initiator bridges 70 than the initiator bridge 70 most responsible for initially filling the queue 78 of the target bridge 72. Based on the throttle response message, the initiator bridge(s) 70 may throttle their rate of transmission over the NOC 46 (process block 128). It should be appreciated that, in all of the examples of this disclosure, the routers 74 may also monitor their own queues 76 and issue throttling commands just like the target bridges 72.

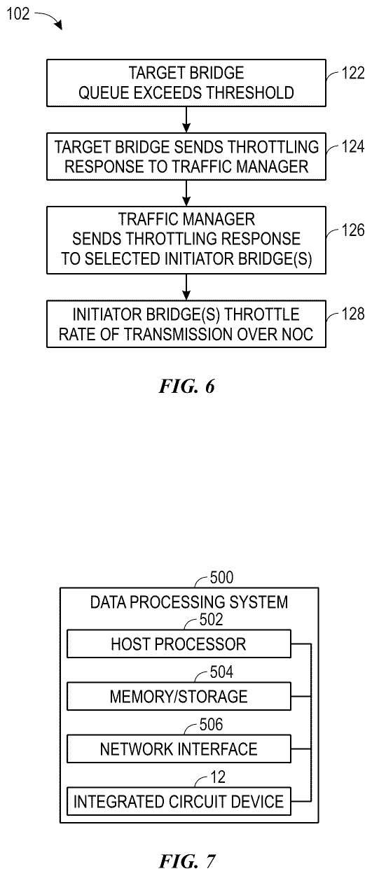

The integrated circuit device 12 discussed above may be a component included in a data processing system, such as a data processing system 500, shown in FIG. 7. The data processing system 500 may include the integrated circuit device 12 (e.g., a programmable logic device, an application specific integrated circuit (ASIC)), a host processor 502, memory and/or storage circuitry 504, and a network interface 506. The data processing system 500 may include more or fewer components (e.g., electronic display, user interface structures, application specific integrated circuits (ASICs)). Moreover, any of the circuit components depicted in FIG. 7 may include the NOC 46 of the integrated circuit device 12. The host processor 502 may include any of the foregoing processors that may manage a data processing request for the data processing system 500 (e.g., to perform encryption, decryption, machine learning, video processing, voice recognition, image recognition, data compression, database search ranking, bioinformatics, network security pattern identification, spatial navigation, cryptocurrency operations, or the like). The memory and/or storage circuitry 504 may include random access memory (RAM), read-only memory (ROM), one or more hard drives, flash memory, or the like. The memory and/or storage circuitry 504 may hold data to be processed by the data processing system 500. In some cases, the memory and/or storage circuitry 504 may also store configuration programs (e.g., bitstreams) for programming the integrated circuit device 12. The network interface 506 may allow the data processing system 500 to communicate with other electronic devices. The data processing system 500 may include several different packages or may be contained within a single package on a single package substrate. For example, components of the data processing system 500 may be located on several different packages at one location (e.g., a data center) or multiple locations. For instance, components of the data processing system 500 may be located in separate geographic locations or areas, such as cities, states, or countries.

The data processing system 500 may be part of a data center that processes a variety of different requests. For instance, the data processing system 500 may receive a data processing request via the network interface 506 to perform encryption, decryption, machine learning, video processing, voice recognition, image recognition, data compression, database search ranking, bioinformatics, network security pattern identification, spatial navigation, digital signal processing, or other specialized tasks.

The techniques and methods described herein may be applied with other types of integrated circuit systems. To provide only a few examples, these may be used with central processing units (CPUs), graphics cards, hard drives, or other components.

While the embodiments set forth in the present disclosure may be susceptible to various modifications and alternative forms, specific embodiments have been shown by way of example in the drawings and have been described in detail herein. However, the disclosure is not intended to be limited to the particular forms disclosed. The disclosure is to cover all modifications, equivalents, and alternatives falling within the spirit and scope of the disclosure as defined by the following appended claims.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

### Example Embodiments

EXAMPLE EMBODIMENT 1. An integrated circuit device comprising:
first circuitry;
second circuitry; and
a network-on-chip (NOC) to transfer packetized data from an initiator bridge connected to the first circuitry to a target bridge connected to the second circuitry and to dynamically limit a transmission rate of the initiator bridge based on a network condition of the NOC.

EXAMPLE EMBODIMENT 2. The integrated circuit device of example embodiment 1, wherein the network condition comprises a fullness of a queue of the target bridge exceeding a threshold.

EXAMPLE EMBODIMENT 3. The integrated circuit device of example embodiment 2, wherein the threshold comprises a programmable static threshold setting.

EXAMPLE EMBODIMENT 4. The integrated circuit device of example embodiment 2, wherein the threshold comprises a dynamically adjusted threshold setting adjusted based on an effect of dynamically limiting the transmission rate of the initiator bridge on the fullness of the queue of the target bridge.

EXAMPLE EMBODIMENT 5. The integrated circuit device of example embodiment 2, wherein the threshold is based at least in part on a metric of the NOC.

EXAMPLE EMBODIMENT 6. The integrated circuit device of example embodiment 5, wherein the metric of the NOC comprises a quality of service (QOS) setting.

EXAMPLE EMBODIMENT 7. The integrated circuit device of example embodiment 5, wherein the metric of the NOC comprises a total number of packets from the initiator bridge in the queue of the target bridge.

EXAMPLE EMBODIMENT 8. The integrated circuit device of example embodiment 1, wherein the network condition comprises a fullness of a queue of a router between the initiator bridge and the target bridge exceeding a threshold.

EXAMPLE EMBODIMENT 9. The integrated circuit device of example embodiment 1, wherein the initiator bridge is dynamically in response to a throttling response packet.

EXAMPLE EMBODIMENT 10. The integrated circuit device of example embodiment 9, wherein the throttling response packet is provided by the target bridge.

EXAMPLE EMBODIMENT 11. The integrated circuit device of example embodiment 9, wherein the throttling response packet is provided by a central traffic manager.

EXAMPLE EMBODIMENT 12. A method comprising:
transmitting data packets from an initiator bridge of a network on chip to a target bridge of the network on chip via one or more routers of the network on chip;
detecting that a queue of the target bridge or of one of the one or more routers exceeds a threshold;
based on detecting that the queue of the target bridge or of the one of the one or more routers exceeds the threshold, issuing a throttling response packet to the initiator bridge; and
based on receiving the throttling response packet at the initiator bridge, dynamically limiting a transmission rate of the initiator bridge.

EXAMPLE EMBODIMENT 13. The method of example embodiment 12, wherein dynamically limiting the transmission rate of the initiator bridge comprises temporarily pausing transmission by the initiator bridge for a threshold amount of time.

EXAMPLE EMBODIMENT 14. The method of example embodiment 12, wherein dynamically limiting the transmission rate of the initiator bridge comprises temporarily reducing the transmission rate to a fixed, lower transmission rate.

EXAMPLE EMBODIMENT 15. The method of example embodiment 12, wherein dynamically limiting the transmission rate of the initiator bridge comprises reducing the transmission rate to a first lower transmission rate for a first threshold amount of time.

EXAMPLE EMBODIMENT 16. The method of example embodiment 15, comprising:
detecting that the queue of the target bridge or of the one or more routers still exceeds the threshold;
based on detecting that the queue of the target bridge or of the one or more routers still exceeds the threshold, issuing an additional throttling response packet to the initiator bridge; and
based on receiving the additional throttling response packet at the initiator bridge within the first threshold amount of time, reducing the transmission rate to a second lower transmission rate lower than the first transmission rate.

EXAMPLE EMBODIMENT 17. Network-on-chip (NOC) circuitry for an integrated circuit device comprising:
a plurality of initiator bridges respectively comprising dynamic throttling circuitry to dynamically throttle their bandwidth based on receipt of a throttling command;
a plurality of routers comprising respective router queues; and
a plurality of target bridges comprising respective target bridge queues;
wherein the throttling command is sent to an initiator bridge of the plurality of initiator bridges based on a fullness of one of the router queues or target bridge queues.

EXAMPLE EMBODIMENT 18. The NOC circuitry of example embodiment 17, wherein the plurality of routers or the plurality of target bridges, or both, comprise throttling response circuitry configured to issue the throttling command based on the fullness of an associated one of the router queues or target bridge queues exceeding a threshold.

EXAMPLE EMBODIMENT 19. The NOC circuitry of example embodiment 17, comprising central traffic manager circuitry configured to issue the throttling command based on the fullness of one of the router queues or target bridge queues exceeding a threshold.

EXAMPLE EMBODIMENT 20. The NOC circuitry of example embodiment 17, wherein the central traffic manager circuitry is configured to issue the throttling command based on a quality of service (QOS) setting of the NOC.

What is claimed is:

1. An integrated circuit device comprising:
first circuitry;
second circuitry; and
a network-on-chip (NOC) to transfer packetized data from an initiator bridge connected to the first circuitry to a target bridge connected to the second circuitry and to dynamically limit a transmission rate of the initiator bridge based on a network condition of the NOC.

2. The integrated circuit device of claim 1, wherein the network condition comprises a fullness of a queue of the target bridge exceeding a threshold.

3. The integrated circuit device of claim 2, wherein the threshold comprises a programmable static threshold setting.

4. The integrated circuit device of claim 2, wherein the threshold comprises a dynamically adjusted threshold setting adjusted based on an effect of dynamically limiting the transmission rate of the initiator bridge on the fullness of the queue of the target bridge.

5. The integrated circuit device of claim 2, wherein the threshold is based at least in part on a metric of the NOC.

6. The integrated circuit device of claim 5, wherein the metric of the NOC comprises a quality of service (QOS) setting.

7. The integrated circuit device of claim 5, wherein the metric of the NOC comprises a total number of packets from the initiator bridge in the queue of the target bridge.

8. The integrated circuit device of claim 1, wherein the network condition comprises a fullness of a queue of a router between the initiator bridge and the target bridge exceeding a threshold.

9. The integrated circuit device of claim 1, wherein the initiator bridge is dynamically in response to a throttling response packet.

10. The integrated circuit device of claim 9, wherein the throttling response packet is provided by the target bridge.

11. The integrated circuit device of claim 9, wherein the throttling response packet is provided by a central traffic manager.

12. A method comprising:
transmitting data packets from an initiator bridge of a network on chip to a target bridge of the network on chip via one or more routers of the network on chip;
detecting that a queue of the target bridge or of one of the one or more routers exceeds a threshold;
based on detecting that the queue of the target bridge or of the one of the one or more routers exceeds the threshold, issuing a throttling response packet to the initiator bridge; and
based on receiving the throttling response packet at the initiator bridge, dynamically limiting a transmission rate of the initiator bridge.

13. The method of claim 12, wherein dynamically limiting the transmission rate of the initiator bridge comprises temporarily pausing transmission by the initiator bridge for a threshold amount of time.

14. The method of claim 12, wherein dynamically limiting the transmission rate of the initiator bridge comprises temporarily reducing the transmission rate to a fixed, lower transmission rate.

15. The method of claim 12, wherein dynamically limiting the transmission rate of the initiator bridge comprises reducing the transmission rate to a first lower transmission rate for a first threshold amount of time.

16. The method of claim 15, comprising:
detecting that the queue of the target bridge or of the one or more routers still exceeds the threshold;
based on detecting that the queue of the target bridge or of the one or more routers still exceeds the threshold, issuing an additional throttling response packet to the initiator bridge; and
based on receiving the additional throttling response packet at the initiator bridge within the first threshold amount of time, reducing the transmission rate to a second lower transmission rate lower than the first transmission rate.

17. Network-on-chip (NOC) circuitry for an integrated circuit device comprising:
a plurality of initiator bridges respectively comprising dynamic throttling circuitry to dynamically throttle their bandwidth based on receipt of a throttling command;
a plurality of routers comprising respective router queues; and
a plurality of target bridges comprising respective target bridge queues;
wherein the throttling command is sent to an initiator bridge of the plurality of initiator bridges based on a fullness of one of the router queues or target bridge queues.

18. The NOC circuitry of claim 17, wherein the plurality of routers or the plurality of target bridges, or both, comprise throttling response circuitry configured to issue the throttling command based on the fullness of an associated one of the router queues or target bridge queues exceeding a threshold.

19. The NOC circuitry of claim 17, comprising central traffic manager circuitry configured to issue the throttling command based on the fullness of one of the router queues or target bridge queues exceeding a threshold.

20. The NOC circuitry of claim 17, wherein the central traffic manager circuitry is configured to issue the throttling command based on a quality of service (QOS) setting of the NOC.
